(19) United States
(12) Patent Application Publication
(10) Pub. No.: US 2010/0094927 A1
(43) Pub. Date: Apr. 15, 2010

(54) PERSONAL WEB OFFICE PORTAL SYSTEM

(76) Inventor: Jeremy Chi Ching Wei, Taipei (TW)

Correspondence Address: AGNEW INTERNATIONAL;PATENT & TRADEMARK LAW FIRM, 7700 Irvine Center Drive, SUITE 800, Irvine, CA, 92618, US

(21) Appl. No.: 12/328,009

(22) Filed: Dec. 4, 2008

Related U.S. Application Data
(60) Provisional application No. 61/104,858, filed on Oct. 13, 2008.

(51) Int. Cl. G06F 15/16

(52) U.S. Cl. 709/203

(57) ABSTRACT

A personal web office portal system for business communications between users is disclosed that is comprised of a web portal system hosted by a computer which contains a web portal that has a communication module; a project tracking module; a scheduling module; a project assignment module; a reminder module; a public access module; and a host access.

### CROSS REFERENCE TO RELATED APPLICATION

This application claims priority of U.S. provisional patent application No. 61/104,858 entitled “Method of Providing Web-Office Platform” which was filed Oct. 13, 2008, and are incorporated herein by reference.

### FIELD OF THE INVENTION

The present invention concerns an online portal that functions as an office front. Specifically a “Personal Web Office” is provided which makes business communications accountable, manageable and traceable, and brings business users, especially IT dummies, closer.

### BACKGROUND OF THE INVENTION

Business users are always laden with a long list of to do things and meetings with other professionals daily. None of these professional communication events are accountable, manageable and traceable manually. Although countless methods such as Microsoft Exchange/Outlook, IBM Lotus, Thunderbird and even Google Calendar are alleged to have solved these problems, pen and paper are still crowned as the best tool to deal with these to do things. The present invention is the answer to this problem. Some of the typical problems professionals faced are outlined here: 1. how can one know his customer's calendar to request a meeting with him, 2. how come one can reach the persona when ever he wants to, 3. how can one keeps his customers informed of his job progress, and allow him to track his job progress, 4. how can one make a request to his business associates and track his progress anytime, 5. how can one arrange a business trip for his boss without asking his calendar and yet is able to keeping him informed timely of the newly scheduled trip, 6. how can one manage and share all these things with right people on Internet, 7. how can one work closely with his customers and associates closely?

The bottom line is that the present art lacks a platform that steers business users away from these messes, and is able makes all business communications accountable, manageable and traceable on Internet without having to require the users to manage an army of IT professionals. In fact, most collaboration solutions in the market, such as WebEx' Web Office, Yahoo's Zimbra and IBM Lotus, focus on the market of workspace collaboration with in-house IT professionals to set up the system, and aim to make work efficiency better and yet none of these solutions provides an effective solution to that is able to meet the needs as discussed earlier. Worse, the vast majority of SMEs, SOHOs and business professionals are not benefitted from these attempted solutions since they cannot afford an in-house IT staffs. The fact that more and more companies refuse to spend money in IT tools for internal work flow but continue to invest heavily in accountable and manageable communication solutions is an indication that of the long standing problem as discussed earlier.

### OBJECT OF THE INVENTION

Therefore, it is the present invention's goal to provide business users for web office front where they would not be able to makes all business communications accountable, manageable and traceable through one internet portal.

### SUMMARY OF THE INVENTION

The present invention discloses a personal web office portal system for business communications between users comprising: a web portal system hosted by a computer wherein said web portal comprises: a communication module; a project tracking module; a scheduling module; a project assignment module; a reminder module; a public access module wherein said access module provides for a secondary users to interact with a primary users through said public access interaction module wherein said interaction module comprises: access for said secondary user to make inquires to the primary user through the communication module; access for said secondary user to make a scheduling event for the primary user through the scheduling module; access for said secondary user to track projects progress of the primary user through the project racking module; access for said secondary user to assigned jobs to the primary user through the job assignment module; access for said secondary user to review the job progress of the primary user through the job progress module; access for said secondary user to schedule reminder to the primary and secondary user based on predetermined scheduled event; host access module wherein said host access module provides said primary user to interact with said secondary user through said host access module wherein said host access module comprises: access for said primary user to make inquires and to reply to said secondary user's inquiry or other primary user through the communication module; access for said primary user to schedule an event for the primary user and other primary users through the scheduling module; access for said primary user to assign jobs to other primary users through said assignment module; access for said primary user to update the project progress through the project tracking module; access for said primary user to schedule reminder to the primary user, secondary user or other primary users through the reminder module.

In one embodiment, the primary user determines whether said secondary user can access the public access module. In another embodiment, the schedule module is further linked to the primary user's preferred calendars. In one way, the primary user can accept or reject the assignment. In another way, the reminder can be in the forms of email, sms txts, or instant messages.

In another embodiment, other primary users can accept or reject the job assignment. In yet another embodiment, the secondary user can access said public access module through the internet.

In another aspect of the invention, a method to conduct business communication between users is disclosed is comprised of: providing a web portal system hosted by a computer wherein said web portal comprises: a communication module; a project tracking module; a scheduling module; a project assignment module; a reminder module; a public access module wherein said access module provides for a secondary users to interact with a primary users through said public access interaction module wherein said interaction module comprises: access for said secondary user to make inquires to the primary user through the communication module; access for said secondary user to make a scheduling event for the primary user through the scheduling module; access for said secondary user to track projects progress of the primary user through the project racking module; access for said secondary user to assigned jobs to the primary user through the job assignment module; access for said secondary user to review the job progress of the primary user through the job progress module; access for said secondary user to schedule reminder to the primary and secondary user based on predetermined scheduled event; host access module wherein said host access module provides said primary user to interact with said secondary user through said host access module wherein said host access module comprises: access for said primary user to make inquires and to reply to said secondary user's inquiry or other primary user through the communication module; access for said primary user to schedule an event for the primary user and other primary users through the scheduling module; access for said primary user to assign jobs to other primary users through said assignment module; access for said primary user to update the project progress through the project tracking module; access for said primary user to schedule reminder to the primary user, secondary user or other primary users through the reminder module. In one embodiment, the communication module further comprises a web meeting module wherein the primary user communicates to the secondary user via the web meeting module. In yet another embodiment, the web meeting module is provided a by a third party provider.

In another embodiment, the present system of claim 1 also comprises: an assistant module wherein the assistant module provides teaching sessions to both the primary and secondary users of how to use the personal web office portal system; a dash board module wherein the dash board module allows said primary user to customize overviews of other modules; a reporting module wherein the reporting module complies and publishes reports of the functions of the other modules; a supervisory module wherein the supervisory module allows one primary user to supervise the progress of another primary user.

In yet another aspect of the invention, a method to generate revenue by providing a primary user with a personal web office portal is devised which comprises providing a web portal system hosted by a computer wherein said web portal comprises: a communication module; a project tracking module; a scheduling module; a project assignment module; a reminder module; a public access module wherein said access module provides for a secondary users to interact with said primary users through said public access interaction module wherein said interaction module comprises access for said secondary user to make inquires to the primary user through the communication module; access for said secondary user to make a scheduling event for the primary user through the scheduling module; access for said secondary user to track projects progress of the primary user through the project racking module; access for said secondary user to assigned jobs to the primary user through the job assignment module; access for said secondary user to review the job progress of the primary user through the job progress module; access for said secondary user to schedule reminder to the primary and secondary user based on predetermined scheduled event; and host access module wherein said host access module provides said primary user to interact with said secondary user through said host access module wherein said host access module comprises access for said primary user to make inquires and to reply to said secondary user's inquiry or other primary user through the communication module; access for said primary user to schedule an event for the primary user and other primary users through the scheduling module; access for said primary user to assign jobs to other primary users through said assignment module; access for said primary user to update the project progress through the project tracking module; access for said primary user to schedule reminder to the primary user, secondary user or other primary users through the reminder module and charging said primary user for a fee wherein said fee corresponds with the number of modules utilized by said primary user.

### BRIEF DESCRIPTION OF THE DRAWING

The present invention satisfies the needs noted above as will become apparent from the following description when read in conjunction with the accompanying drawings wherein:

FIG. 1 is a system diagram showing the personal web office portal system of the present invention where the web portal system is comprised of a communication module; a project tracking module; a scheduling module; a project assignment module; a reminder module; a public access module; and a host access module.

FIG. 2 is a system diagram showing an alternate embodiment of the web portal system of the present invention disclosing multiples primary users and secondary users using the system.

FIG. 3 is a system diagram showing an alternate embodiment of the web portal system of the present invention disclosing scheduling module in synchronization with primary user's preferred calendar.

FIG. 4 is a system diagram showing the personal web office portal system of the present invention where the web portal system is comprised of a communication module; a project tracking module; a scheduling module; a project assignment module; a reminder module; a supervisory module, a reporting module, a dash board module and an assistant module; a public access module; and a host access module.

### DETAILED DESCRIPTION OF THE DRAWINGS

The present invention allows every user to create a personal web office at no cost, and make it public for visitors. Users are categorized into two groups: a. primary users who are the service providers and b. secondary users who are rendering services. In effect, the personal web office contains of a public area for Visitors (secondary users) to communicate with Host (primary users), as well as a privileged area for Host (primary users) to reply to Visitors (secondary users). All communications between Host and Visitors are accountable and traceable. Typical Hosts can be entrepreneurs, staffs, managers, assistants, doctors, lawyers, journalists, salesmen, technicians and teachers.

Host and Visitors may access web offices from PC, laptop and mobile phone, and communicate with each other as if they would be at a real office. Visitor View is the Public Area where it is a public area for Visitors to make requests, schedule web meetings with Host, be kept informed by reminders through emails, instant messages, and SMS, and track progress.

On the other end of this system is the Host View (Privileged Area). In particular, privileged area for Host provides functions like: updating visitors of any progress by reminders, replying to Visitors, assigning jobs to associates, tracking job progress, sharing files with other users and communicating with visitors through web meetings.

One advantage to the present invention is that legacy “ToDo” lists and email tools used to archive messages by in-and-out box are no longer efficient enough to keep up with the ever changing pace of current professional landscape. Users cannot immediately obtain a clear picture of process and progress related to a specific subject. The present invention provides for tracking processes and progresses and categorizes all messages by using a blogging style approach. Any of new messages will be labeled with an icon of status such as “New”, “In Progress” and “Done”, and stacked atop old ones by subjects. Users are easy to follow up by subject and status.

The present invention delivers a variety of functional services to business users on a selected module approach. For example, users will be able to easily re-model their offices in accordance with for personalized demands of business users such as entrepreneurs, staffs, managers, assistants, doctors, lawyers, journalists, salesmen, technicians and teachers and select individual modules that they wish to activate for their personal web office.

The present invention also provides additional functional modules such as assistant module, dash board module, reporting module and supervision module. The assistant module will provide teaching sessions to both the primary and secondary users of how to use the web office system. The dashboard module allows the users to view and manage customized views of the all the functional modules to which would allow the users to manage easily. The reporting module is able to compile and publish reports for the users. Example of reports would be the amount of inquires per week, the average speed to which inquiries are replied to and etc. Supervision module allows primary users to supervisor the progress of other primary users. One example of supervision module's function would be that the module would send reminders via reminder module to inform the primary user if certain job progress is not met.

The present invention presents for users the ability to experience a fresh communication approach with customers, partners and business associates whereby the result is the increases of accountability of business communications, and the reductions of the cost and the time of business development.

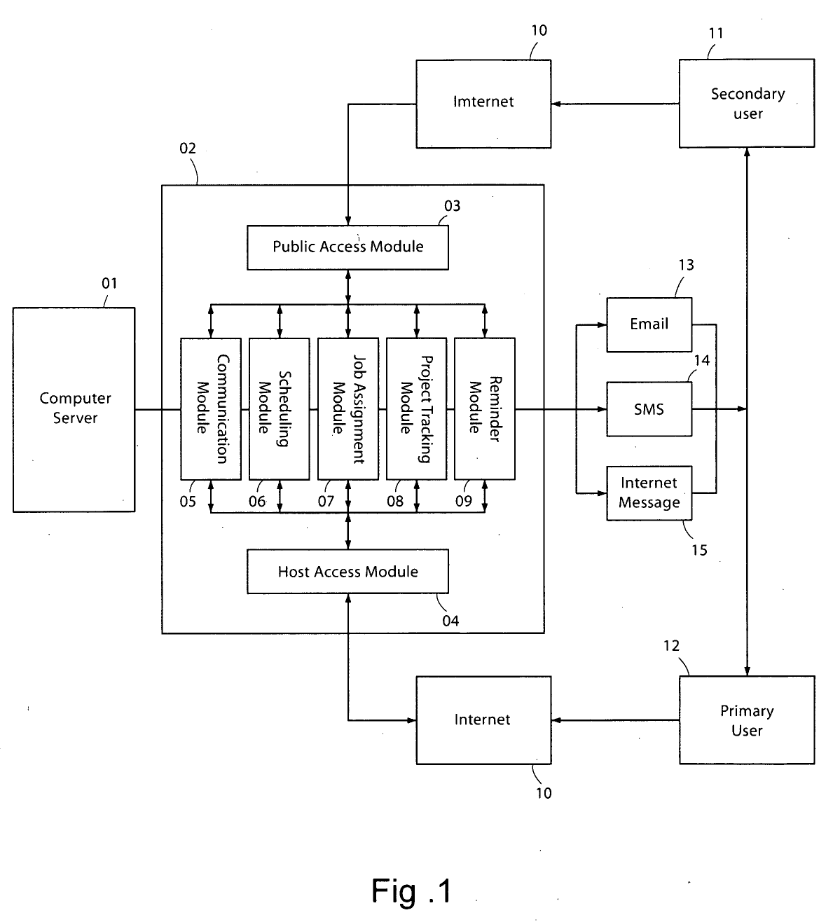

Referring now to the drawings, FIG. 1 is an example system diagram showing the Web official portal system for business communication between users comprising a web portal system 02 hosted by a computer 01 wherein said portal is comprised of a communication module 05, a project tracking module 08, a scheduling module 06, a project assignment module 08, a reminder module 09, a public access module 03 and a host access module 04.

Specifically in FIG. 1, the web portal system 02 resides in a computer server 01. The web portal system 02 is connected typically to the internet 10. The web portal system 02 is comprised of some basic functional modules. The first functional module is a communication module 05 wherein a secondary user 11, which is typically a client, a customer, would via internet 10 use the communication module 05 through the public access module 03 where the secondary user 11 would make inquires by leaving a blog style message to the primary user 12 which is typically the user providing the services or goods to the secondary user 11. In particular, a primary user 12 can be an accountant, a lawyer, a customer service representative, an architect and so forth. Here, the secondary user 12 can then via the internet 10 to access the host access module 04 to respond to the secondary user 11. The second functional module is a scheduling module 06 where a secondary user 11 would be able to view the schedules of the primary user 12 and even been able to make changes and schedule meeting with the primary user 12. Here the primary user 12 can reject or accept the scheduled meetings. The third functional module is the job assignment module 07. Here, the secondary user 11 can assign jobs to the primary user 12 and primary user 12 can decide if he or she wants to accept the job assignment. Likewise, a primary user 12 would be able to assign jobs to the other primary user. The fourth functional module is a project tracking module 08 where the primary user 12 would update the progress of the projects that he or she is working on and the secondary user 11 would be able to retrieve and review the progress of the module. In one embodiment, the users can leave comments to the job progress module, in another embodiment secondary user 11 may be able to make changes to the progress of the project tracking module 08. The fifth module is a reminder module 09. Here, the primary user 12 or secondary user 11 can request that based on a pre-scheduled event the reminder module 09 would send out reminder to the users, whether it being the user itself or other designated user in the system. The reminder can be in the form of email, “sms”, or even in instant message.

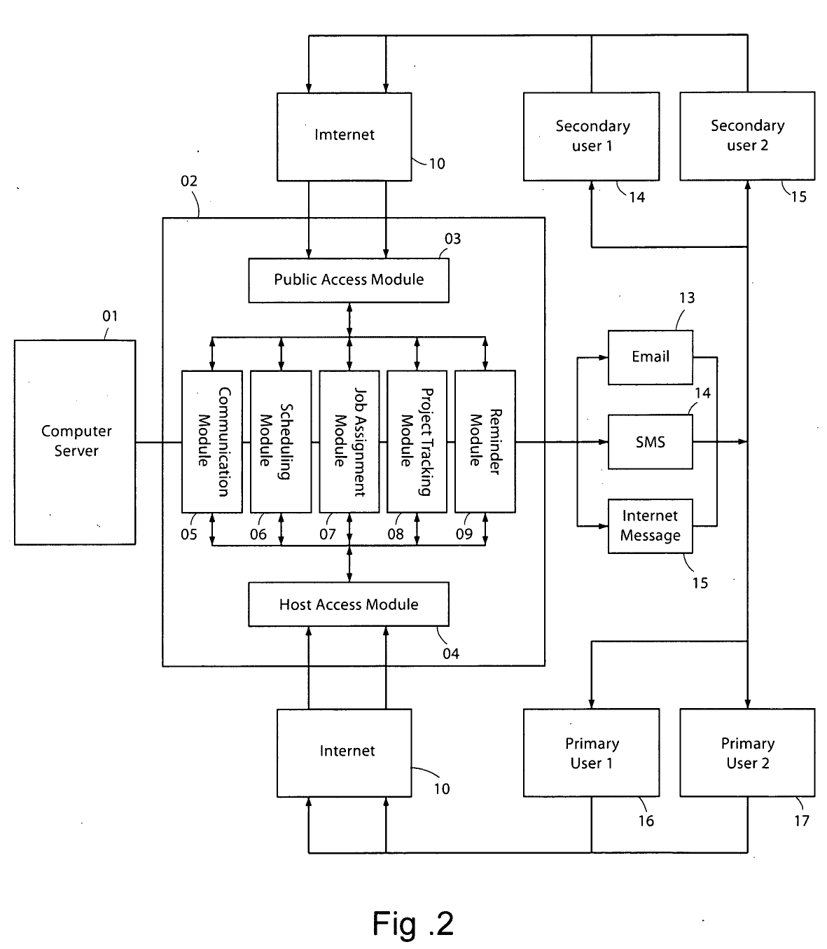

FIG. 2 discloses an alternate embodiment of the present invention. Here the system can supports multiple secondary users and multiple primary users. Specifically, in this preferred embodiment, primary user 1 16 can assign jobs to primary user 2 17 via the job assignment modules 07. Likewise, a primary user 1 16 can make inquires, track job progresses and schedule calendar event to the primary user 2 17. In one embodiment, the primary users can decide which primary users are linked to them. In another embodiment, they can decide the level of access that each user is able to access. The level of access can be by determining which modules are allowed for access. The other level of access can be by determining the which features to activate within the modules.

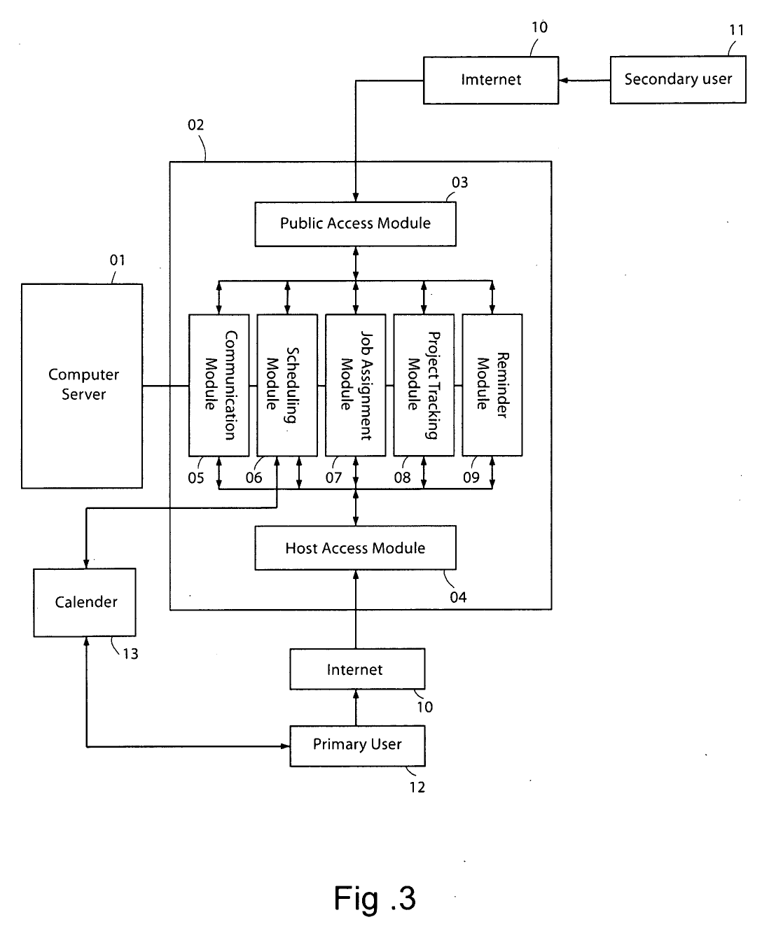

In FIG. 3 the same invention is disclosed as in FIG. 1, except that here the scheduling module 06 is linked to the primary user's calendar 13 which is not part of the personal web office portal system 02. The linking can be in the form of synchronization. For example, the primary user 12 may have a preferred calendar such as Google calendar, Yahoo calendar or the likes and scheduling module 06 would be able to synchronize with such calendar 13.

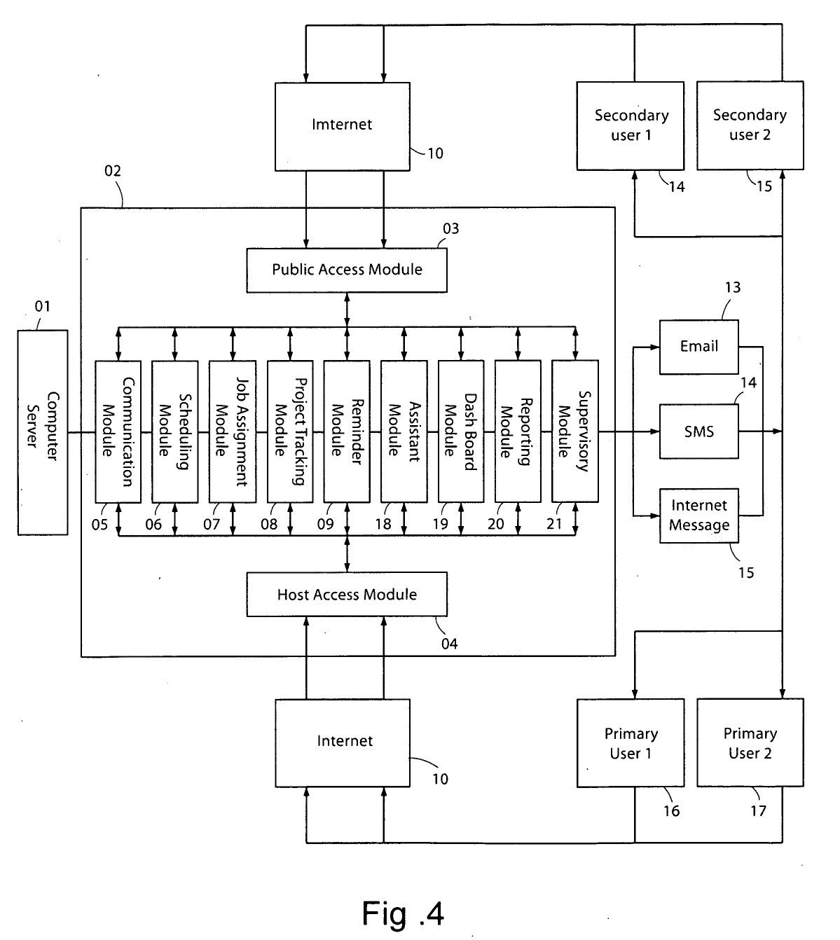

In FIG. 4, the web portal system 02 resides in a computer server 01. The web portal system 02 is connected typically to the internet 10. The web portal system 02 is comprised of some basic functional modules. The first functional module is a communication module 05 wherein a secondary user 11, which is typically a client, a customer, would via internet 10 use the communication module 05 through the public access module 03 where the secondary user 11 would make inquires by leaving a blog style message to the primary user 12 which is typically the user providing the services or goods to the secondary user 11. In particular, a primary user 12 can be an accountant, a lawyer, a customer service representative, an architect and so forth. Here, the secondary user 12 can then via the internet 10 to access the host access module 04 to respond to the secondary user 11. The second functional module is a scheduling module 06 where a secondary user 11 would be able to view the schedules of the primary user 12 and even been able to make changes and schedule meeting with the primary user 12. Here the primary user 12 can reject or accept the scheduled meetings. The third functional module is the job assignment module 07. Here, the secondary user 11 can assign jobs to the primary user 12 and primary user 12 can decide if he or she wants to accept the job assignment. Likewise, a primary user 12 would be able to assign jobs to the other primary user. The fourth functional module is a project tracking module 08 where the primary user 12 would update the progress of the projects that he or she is working on and the secondary user 11 would be able to retrieve and review the progress of the module. In one embodiment, the users can leave comments to the job progress module, in another embodiment secondary user 11 may be able to make changes to the progress of the project tracking module 08. The fifth module is a reminder module 09. Here, the primary user 12 or secondary user 11 can request that based on a pre-scheduled event the reminder module 09 would send out reminder to the users, whether it being the user itself or other designated user in the system. The reminder can be in the form of email, “sms”, or even in instant message. The sixth module is an assistant module 18 where it will provide teaching sessions to both the primary and secondary users of how to use the web office system. An example of teaching sessions would be the passive Q&A sessions. The seventh module is a dashboard module 19 which allows the users to view and manage customizable overviews of the all the functional modules to which would allow the users to manage easily. The eighth module is the reporting module 20 where a reporting module 20 is able to compile and publish reports for the users. Examples of reports would be the amount of inquires per week, the average speed to which inquiries are replied to, the average length of job assignment acceptance time and so forth. The ninth module is a Supervisory module 21 which allows primary users to supervisor the progress of other primary users in many contexts. One example of supervision module's function would be that the module would send reminders via reminder module 09 to inform the primary user 1 16 if certain job progress of primary user 2 17 if the job progression target is not met. Another example of the function within the supervisory module 21 is that primary user 1 can monitor access the reports within the reporting module 20 of primary user 2 17 thereby effectively monitoring primary user 2's efficiency as a worker.

It is appreciated by persons skilled in the art that the present invention is not limited by what has been particularly shown and described hereinabove. Rather the scope of the present invention includes both combinations and subcombinations of the features described hereinabove as well as modifications and variations thereof which would occur to a person of skill in the art upon reading the foregoing description and which are not in the prior art.

What is claimed is:

1. A personal web office portal system for business communications between users comprising: a web portal system hosted by a computer wherein said web portal comprises:
a. a communication module;
b. a project tracking module;
c. a scheduling module;
d. a project assignment module;
e. a reminder module;
f. a public access module wherein said access module provides for a secondary users to interact with a primary users through said public access interaction module wherein said interaction module comprises:
i. access for said secondary user to make inquires to the primary user through the communication module;
ii. access for said secondary user to make a scheduling event for the primary user through the scheduling module;
iii. access for said secondary user to track projects progress of the primary user through the project racking module;
iv. access for said secondary user to assigned jobs to the primary user through the job assignment module;
v. access for said secondary user to review the job progress of the primary user through the job progress module;
vi. access for said secondary user to schedule reminder to the primary and secondary user based on predetermined scheduled event;
g. host access module wherein said host access module provides said primary user to interact with said secondary user through said host access module wherein said host access module comprises:
i. access for said primary user to make inquires and to reply to said secondary user's inquiry or other primary user through the communication module;
ii. access for said primary user to schedule an event for the primary user and other primary users through the scheduling module;
iii. access for said primary user to assign jobs to other primary users through said assignment module;
iv. access for said primary user to update the project progress through the project tracking module;
v. access for said primary user to schedule reminder to the primary user, secondary user or other primary users through the reminder module.

2. The system of claim 1 wherein said primary user determines whether said secondary user can access the public access module.

3. The system of claim 1 wherein said scheduling module is further linked to the primary user's preferred calendars.

4. The system of claim 1 wherein the primary user can accept or reject the assignment.

5. The system of claim 1 wherein the reminder can be in the forms of email, sms txts, or instant messages.

6. The system of claim 1 wherein other primary user can accept or reject the job assignment.

7. The system of claim 1 wherein said secondary user can access said public access module through the internet.

8. The system of claim 1 wherein said web portal further comprises:
a. an assistant module wherein said assistant module provides teaching sessions to both the primary and secondary users of how to use the personal web office portal system;
b. a dash board module wherein said dash board module allows said primary user to customize overviews of other modules;
c. a reporting module wherein said reporting module complies and publishes reports of the functions of the other modules;
d. a supervisory module wherein said supervisory module allows one primary user to supervise the progress of another primary user.

9. The system of claim 1 wherein said communication module provides communication between users via a blogging style method.

10. The system of claim 1 wherein said communication module further comprises a web meeting module wherein said primary user communicate to said secondary user via said web meeting module.

11. The system of claim 10 wherein said web meeting module is provided a by a third party provider.

12. A method to method to conduct business communication between users comprising:
a. providing a web portal system hosted by a computer wherein said web portal comprises:
i. a communication module;
ii. a project tracking module;
iii. a scheduling module;
iv. a project assignment module;
v. a reminder module;
vi. a public access module wherein said access module provides for a secondary users to interact with a primary users through said public access interaction module wherein said interaction module comprises:
1. access for said secondary user to make inquires to the primary user through the communication module;
2. access for said secondary user to make a scheduling event for the primary user through the scheduling module;
3. access for said secondary user to track projects progress of the primary user through the project racking module;
4. access for said secondary user to assigned jobs to the primary user through the job assignment module;
5. access for said secondary user to review the job progress of the primary user through the job progress module;
6. access for said secondary user to schedule reminder to the primary and secondary user based on predetermined scheduled event;
vii. host access module wherein said host access module provides said primary user to interact with said secondary user through said host access module wherein said host access module comprises:
1. access for said primary user to make inquires and to reply to said secondary user's inquiry or other primary user through the communication module;
2. access for said primary user to schedule an event for the primary user and other primary users through the scheduling module;
3. access for said primary user to assign jobs to other primary users through said assignment module;
4. access for said primary user to update the project progress through the project tracking module;
5. access for said primary user to schedule reminder to the primary user, secondary user or other primary users through the reminder module.

13. The method of claim 12 wherein said primary user determines whether said secondary user can access the public access module.

14. The method of claim 12 wherein said schedule module is further linked to the primary user's preferred calendars.

15. The method of claim 12 wherein the primary user can accept or reject the assignment.

16. The method of claim 12 wherein the reminder can be in the forms of email, sms txts, or instant messages.

17. The method of claim 12 wherein other primary user can accept or reject the job assignment.

18. The method of claim 12 wherein said secondary user can access said public access module through the internet.

19. The method of claim 12 where wherein said web portal further comprises:
a. an assistant module wherein said assistant module provides teaching sessions to both the primary and secondary users of how to use the personal web office portal system;
b. a dash board module wherein said dash board module allows said primary user to customize overviews of other modules;
c. a reporting module wherein said reporting module complies and publishes reports of the functions of the other modules;
d. a supervisory module wherein said supervisory module allows one primary user to supervise the progress of another primary user.

20. A method to generate revenue by providing a primary user with a personal web office portal comprising:
a. providing a web portal system hosted by a computer wherein said web portal comprises:
i. a communication module;
ii. a project tracking module;
iii. a scheduling module;
iv. a project assignment module;
v. a reminder module;
vi. a public access module wherein said access module provides for a secondary users to interact with said primary users through said public access interaction module wherein said interaction module comprises:
1. access for said secondary user to make inquires to the primary user through the communication module;
2. access for said secondary user to make a scheduling event for the primary user through the scheduling module;
3. access for said secondary user to track projects progress of the primary user through the project racking module;
4. access for said secondary user to assigned jobs to the primary user through the job assignment module;
5. access for said secondary user to review the job progress of the primary user through the job progress module;
6. access for said secondary user to schedule reminder to the primary and secondary user based on predetermined scheduled event;
vii. host access module wherein said host access module provides said primary user to interact with said secondary user through said host access module wherein said host access module comprises:
1. access for said primary user to make inquires and to reply to said secondary user's inquiry or other primary user through the communication module;
2. access for said primary user to schedule an event for the primary user and other primary users through the scheduling module;
3. access for said primary user to assign jobs to other primary users through said assignment module;
4. access for said primary user to update the project progress through the project tracking module;
5. access for said primary user to schedule reminder to the primary user, secondary user or other primary users through the reminder module;
b. charging said primary user for a fee wherein said fee corresponds with the number of modules utilized by said primary user.
